(19) United States
(12) Patent Application Publication
(10) Pub. No.: US 2026/0154321 A1
(43) Pub. Date: Jun. 4, 2026

(54) TECHNOLOGY-INTEGRATED APPARATUS AND METHOD FOR DETERMINING SEMANTIC CORRELATION BETWEEN STRUCTURED AND UNSTRUCTURED DATA AND FOR HIGH-ACCURACY DATA RETRIEVAL RELEVANT TO QUERY

(71) Applicant: POSTECH RESEARCH AND BUSINESS DEVELOPMENT FOUNDATION, Pohang-si (KR)

(72) Inventors: Wook-Shin HAN, Pohang-si (KR); Sungho PARK, Pohang-si (KR); Joohyung YUN, Pohang-si (KR); Jeong-Hoon LEE, Pohang-si (KR)

(73) Assignee: POSTECH RESEARCH AND BUSINESS DEVELOPMENT FOUNDATION, Pohang-si (KR)

(21) Appl. No.: 19/283,091

(22) Filed: Jul. 28, 2025

(30) Foreign Application Priority Data
Dec. 4, 2024 (KR) 10-2024-0178976
Feb. 5, 2025 (KR) 10-2025-0014151

(51) Int. Cl. G06F 16/36; G06F 16/3329; G06F 16/334

(52) U.S. Cl. CPC G06F 16/367; G06F 16/3329; G06F 16/334

(57) ABSTRACT

An electronic device, which determines semantic correlations between structured and unstructured data and data retrieval in response to natural language queries, may include circuits, such as a data-acquisition circuit, a data-division circuit, and other circuits. Together, these circuits may acquire tabular data organized into rows and a query. The circuits may also divide the tabular data, construct various graphs including the tabular data, and determine similarity coefficients for the tabular data and the query. Based on these graphs and similarity coefficients, the circuits may construct an expanded graph by modifying the modified graph based on the modified graph, as well as an expanded result graph based on relevance between the expanded graph and the query. After constructing the expanded graph and expanded result graph, the circuits may store or transmit one or more of the expanded graph and the expanded result.

### CROSS-REFERENCE TO RELATED APPLICATIONS

This application claims the benefit of and priority to Korean Patent Application No. 10-2024-0178976 filed on Dec. 4, 2024 and Korean Patent Application No. 10-2025-0014151 filed on Feb. 5, 2025, in the Korean Intellectual Property Office, the entire contents of each of which are incorporated herein by reference for all purposes.

### TECHNICAL FIELD

The disclosure relates to a technology-integrated apparatus and method, and particularly to, for example, without limitation, a technology-integrated apparatus and method for determining semantic correlation between structured data and unstructured data and high-accuracy data retrieval relevant to a query.

### BACKGROUND

Recently, the use of open-type question-answering systems that replace search engines has been on the rise. Users of existing search engines had to enter a question into a search engine, and then navigate through multiple documents and compare various results in order to find the information they desired. In particular, for data in different formats, such as data consisting of tabular data and text, it took time and cost to identify the mutual relevance between the data.

To address these issues, early fusion and late fusion can be used, but both methods have limitations in that they fail to perform accurate searches. For example, in early fusion, since pairs of tabular data segments and documents are formed before a question is given, tabular data and/or documents with low relevance to the question may be included in the search results, which may result in low precision and accuracy of the search. In addition, for example, late fusion has limitations in that a single document alone may only partially contain the information necessary to determine the relevance to a question, and thus it is difficult to accurately determine the relevance to a question with a single document alone and the search accuracy is low.

To solve these problems, there has been a need for a technology that can effectively identify the semantic relationship between tabular data and text and quickly search and provide data relevant to a question.

The description in the background section should not be considered prior art merely because it is mentioned in or associated with this section. The description in the background section includes information that describes one or more aspects of the subject technology, and the description in this section does not limit the scope of the invention.

### SUMMARY

It is an aspect of the present disclosure to provide a technology-integrated apparatus and method according to a query, which can provide search results by reflecting the semantic relationship between tabular data and text.

The aspects of the present disclosure are not limited to the aspects mentioned above, and other aspects and advantages of the present disclosure that have not been mentioned can be understood through the following description and will be more clearly understood with the embodiments of the present disclosure. Moreover, it will be readily appreciated that the aspects and advantages of the present disclosure can be realized by the means set forth in the claims and combinations thereof.

According to some aspects of the disclosure, an electronic device for determining semantic correlations between structured data and unstructured data and data retrieval in response to queries, includes a data-acquisition circuit configured to acquire tabular data organized into rows and a query for querying the tabular data. The electronic device also includes a data-division circuit configured to divide the tabular data into tabular data segments each comprising one or more of the rows. Additionally, the electronic device includes a first graph-construction circuit configured to construct an initial graph comprising first pairs of tabular data segments and documents relating to the tabular data segments. Further, the electronic device includes a first similarity-determination circuit configured to determine first similarity coefficients between the query and each of the first pairs of the tabular data segments and documents. Moreover, the electronic device includes a second graph-construction circuit configured to construct a subgraph that is part of the initial graph based on the first similarity coefficients. Furthermore, the electronic device includes a first data-identification circuit configured to identify, based on the subgraph, at least one of new tabular data segments and new documents that are different from each of the tabular data segments of the subgraph and the documents of the subgraph included in the subgraph. Additionally, the electronic device includes a second data-identification circuit configured to identify at least one second pair of a tabular data segment and a document which is at least part of the new tabular data segments and the new documents. Further, the electronic device includes a third graph-construction circuit configured to construct a modified graph by adding the at least one second pair of the tabular data segment and the document to the subgraph. Moreover, the electronic device includes a fourth graph-construction circuit configured to construct an expanded graph by modifying the modified graph based on the modified graph. Furthermore, the electronic device includes a fifth graph-construction circuit configured to construct an expanded result graph based on relevance between the expanded graph and the query. Additionally, the electronic device includes a data-handling circuit configured to store or transmit one or more of the expanded graph and the expanded result graph.

According to some aspects of the disclosure, a computer-implemented method for determining semantic correlations between structured data and unstructured data and data retrieval in response to queries, includes acquiring tabular data organized into rows and a query for querying the tabular data. The computer-implemented method also includes dividing the tabular data into tabular data segments each comprising one or more of the rows. Additionally, the computer-implemented method includes constructing an initial graph comprising first pairs of tabular data segments and documents relating to the tabular data segments. Further, the computer-implemented method includes determining first similarity coefficients between the query and each of the first pairs of the tabular data segments and documents. Moreover, the computer-implemented method includes constructing a subgraph that is part of the initial graph based on the first similarity coefficients. Furthermore, the computer-implemented method includes identifying, based on the subgraph, at least one of new tabular data segments and new documents that are different from each of the tabular data segments of the subgraph and the documents of the subgraph included in the subgraph. Additionally, the computer-implemented method includes identifying at least one second pair of a tabular data segment and a document, which is at least part of the new tabular data segments and the new documents. Further the computer-implemented method includes constructing a modified graph by adding the at least one second pair of the tabular data segment and the document to the subgraph. Moreover, the computer-implemented method includes constructing an expanded graph by modifying the modified graph based on the modified graph. Furthermore, the computer-implemented method includes constructing an expanded result graph based on relevance between the expanded graph and the query. Additionally, the computer-implemented method includes storing or transmitting one or more of the expanded graph and the expanded result graph.

The technology-integrated apparatus and method according one or more aspects of the present disclosure can allow users to efficiently search structured data (e.g., tabular data) and unstructured data (e.g., documents or text) and enable data highly relevant to the question to be searched quickly by taking into account the relevance between tabular data and the question and the relevance between documents and the question and expanding the search results.

Further, the technology-integrated apparatus and method according one or more aspects of the present disclosure can provide search results highly relevant to the question by taking into account the relevance between tabular data and the question and the relevance between documents and the question and expanding the search results.

Moreover, advancements in technologies that improve semantic understanding between structured data (e.g., tabular data) and unstructured data (e.g., free-form text such as documents) offer significant benefits for open-type query-answering systems. By accurately capturing and evaluating the contextual and semantic relationships between disparate data formats, the innovations described herein can dramatically improve the relevance and precision of responses to user queries. This enhanced relevance reduces the cognitive load on users by minimizing the need to review multiple sources or perform manual cross-referencing between documents and/or tabular data, thereby improving overall user experience and efficiency.

Furthermore, improved integration of structured and unstructured data in response to natural language queries can enhance system adaptability across domains such as healthcare, finance, legal research, and scientific discovery, where critical information is often spread across heterogeneous formats. Innovations in this area may also reduce computational overhead by enabling more targeted data retrieval and ranking strategies, ultimately supporting faster response times and better scalability for large-scale question-answering systems.

In addition to the descriptions above, specific effects of the present disclosure will be described together while describing specific details for implementing the present disclosure below.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a diagram for describing a technology-integrated apparatus in accordance with embodiments of the present disclosure.

FIG. 2 is an example flowchart for describing the operation of the processor of FIG. 1.

FIG. 3 is an example diagram for describing step S100 of FIG. 2.

FIGS. 4A and 4B are example diagrams for describing step S100 of FIG. 2.

FIG. 5 is an example diagram for describing step S200 of FIG. 2.

FIG. 6 is an example diagram for describing step S300 of FIG. 2.

FIG. 7 is an example diagram for describing step S400 of FIG. 2.

FIG. 8 is an example diagram for describing steps S401, S403, and S405 of FIG. 7.

FIG. 9 is an example diagram for describing step S411 of FIG. 7.

FIG. 10 is an example diagram for describing step S500 of FIG. 2.

FIG. 11 is an example diagram for describing step S600 of FIG. 2.

FIG. 12 is an example diagram for describing step S700 and step S800 of FIG. 2.

FIGS. 13A and 13B are example diagrams for describing steps S703 and S705 of FIG. 12.

FIG. 14 is an example diagram for describing step S707 of FIG. 12.

FIG. 15 is an example diagram for describing step S709 of FIG. 12.

FIG. 16 is an example diagram for describing step S711 of FIG. 12.

FIG. 17 is an example diagram for describing step S713 of FIG. 12.

FIG. 18 is an example diagram for describing step S900 and step S1000 of FIG. 2.

FIG. 19A is an example flowchart for describing a technology-integrated method in accordance with an embodiment of the present disclosure.

FIG. 19B is an example circuit diagram for implementing a technology-integrated apparatus.

Throughout the drawings and the detailed description, unless otherwise described, the same drawing reference numerals should be understood to refer to the same elements, features, and structures.

### DETAILED DESCRIPTION

Reference is now made in detail to embodiments of the present disclosure, examples of which may be illustrated in the accompanying drawings. In the following description, when a detailed description of well-known methods, functions, structures or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

When the term “comprise,” “have,” “include,” “contain,” “constitute,” “made of,” “formed of,” “composed of,” or the like is used with respect to one or more elements (e.g., components, portions, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information is construed to include an error or tolerance range even where no explicit description of such an error or tolerance range is provided. An error or tolerance range may be caused by various. In interpreting a numerical value, the value is interpreted as including an error range unless explicitly stated otherwise.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

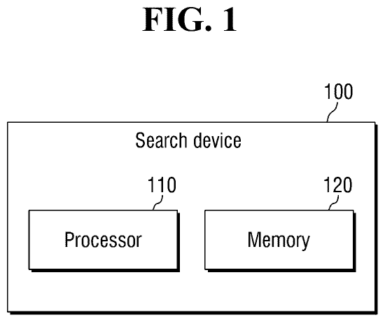

FIG. 1 is a diagram for describing a technology-integrated apparatus in accordance with embodiments of the present disclosure.

Referring to FIG. 1, the technology-integrated apparatus, for example, a search device 100 may include a processor 110 and a memory 120.

One or more other components (e.g., a communication module) may be added to the search device 100. In some embodiments, some of these components may be implemented in a single integrated circuit.

The search device 100 may receive as input a question from the outside (e.g., a user) and provide search results (e.g., a final graph) that are highly relevant to the question. The search results may include tabular data segments and/or documents.

The memory 120 may store various data used by at least one component (e.g., the processor 110) of the search device 100. The data may include, for example, software (e.g., programs) and input data or output data for commands associated therewith. The memory 120 may include volatile memory or nonvolatile memory.

The memory 120 may store commands, information, or data associated with the operations of the components included in the search device 100. For example, the memory 120 may store instructions that, when executed, cause the processor 110 to perform various operations described herein.

The processor 110 may be operatively coupled with the memory 120 in order to perform the overall functions of the search device 100. The processor 110 may include, for example, one or more processors. The one or more processors may include, for example, an image signal processor (ISP), an application processor (AP), or a communication processor (CP).

The processor 110 may control at least one other component (e.g., a hardware or software component) of the search device 100 connected to the processor 110, for example, by executing software (e.g., a program), and may perform various data processing or calculations. According to one embodiment, as at least part of the data processing or calculations, the processor 110 may load commands or data received from other components (e.g., a communication module) into the memory 120, process the commands or data stored in the memory 120, and store the result data in the memory 120. According to one embodiment, the processor 110 may include a main processor (e.g., a central processing unit or application processor), and an auxiliary processor (e.g., a graphics processing unit, an image signal processor, a sensor hub processor, or a communication processor) that can operate independently of or together with the main processor. Additionally or alternatively, the auxiliary processor may be set to use less power than the main processor, or to be specialized for a given function. The auxiliary processor may be implemented separately from or as a part of the main processor. The program may be stored as software in the memory 120, and may include, for example, an operating system, middleware, or an application.

In the following, the operation of the processor 110 will be described.

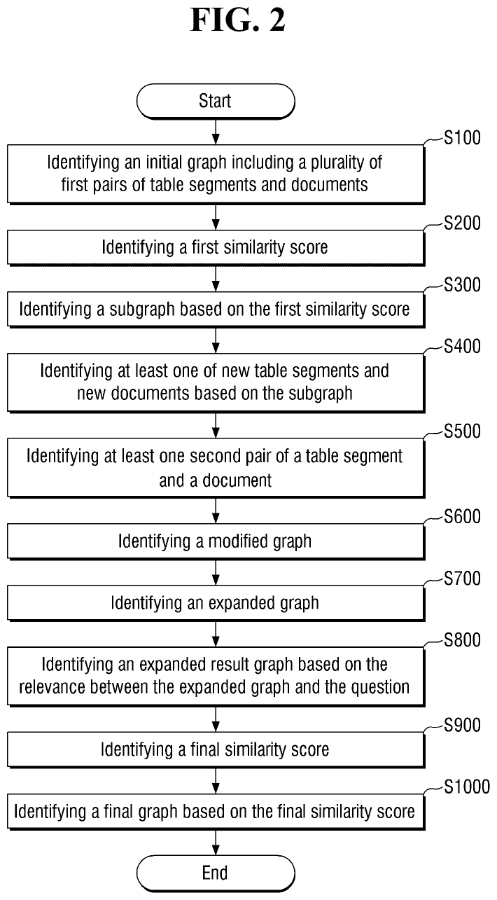

FIG. 2 is a flowchart for describing the operation of the processor of FIG. 1.

Referring to FIGS. 1 and 2, the processor 110 may identify an initial graph including a plurality of first pairs of tabular data segments and documents (S100).

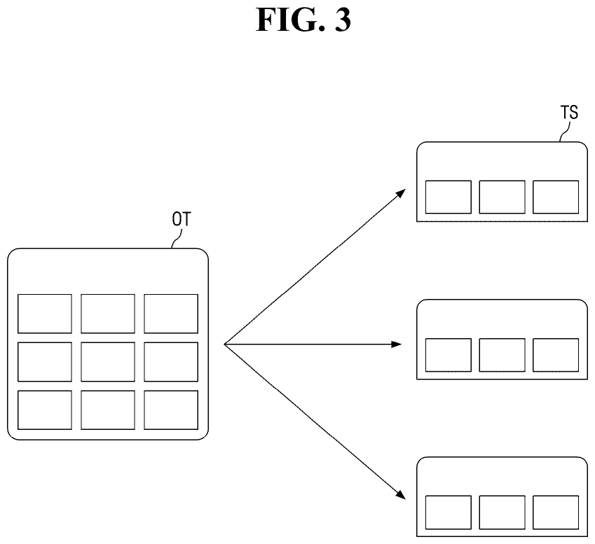

FIG. 3 is a diagram for describing step S100 of FIG. 2.

Referring to FIG. 3, the processor 110 may first divide a table (e.g., an original table (tabular data)) OT into tabular data segments TS in order to identify the initial graph. The tabular data segments TS may be obtained by dividing the table OT based on the rows of the table OT. The processor 110 may identify the tabular data segments TS obtained by dividing the table OT based on the rows.

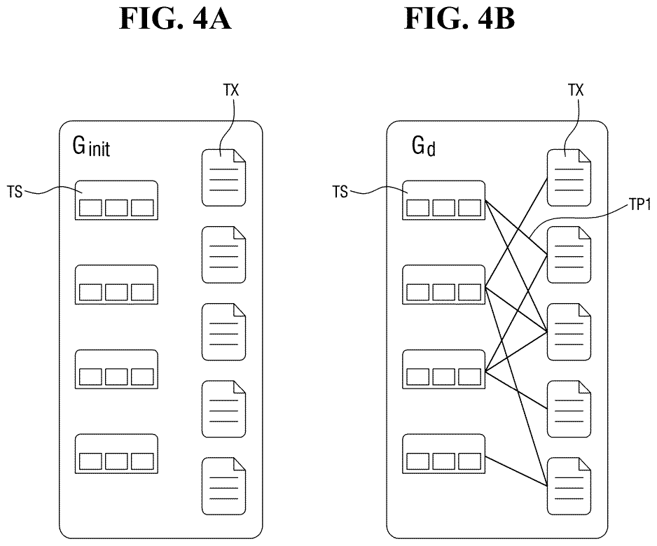

FIGS. 4A and 4B are example diagrams for describing step S100 of FIG. 2.

Referring to FIG. 4A, the processor 110 may identify a data pool graph Gint including at least one tabular data segment TS and at least one document TX. The document TX may include text and may be data of a type different from the tabular data segment TS.

Referring to FIG. 4B, the processor 110 may identify pairs by associating at least one tabular data segment TS and at least one document TX included in the data pool graph Gint with each other based on their relevance to each other. The processor 110 may identify an initial graph Gd including a plurality of first pairs TP1 of tabular data segments and documents, in each of which a tabular data segment TS and a document TX are paired. The paired documents TX and tabular data segments TS may be related to each other. A single tabular data segment TS may be paired with, for example, a plurality of documents TX. A single document TX may be paired with, for example, a plurality of tabular data segments TS. For example, the initial graph Gd of FIG. 4B may include a total of nine first pairs TP1 of the tabular data segments and documents.

In some embodiments, the initial graph Gd may be formed in an early fusion method.

The processor 110 may identify the initial graph Gd based on the data pool graph Gint. Alternatively, the processor 110 may identify the initial graph Gd by receiving the initial graph Gd from the outside.

Referring again to FIGS. 1 and 2, the processor 110 may identify a first similarity coefficient (S200). The processor 110 may identify a first similarity coefficient between the question and each of the plurality of first pairs of the tabular data segments and documents.

The question may be data received from the outside (e.g., a user). The processor 110 may identify the first similarity coefficient in order to identify the relevance between the question and the plurality of first pairs TP1 of the tabular data segments and documents included in the initial graph (Gd in FIG. 4B). The first similarity coefficient may be identified for each of the plurality of first pairs TP1 of the tabular data segments and documents and the question, thereby including a plurality of similarity coefficients.

For example, the processor 110 may identify a similarity coefficient indicating the relevance between one pair of the table segment and document included in the initial graph (Gd in FIG. 4B) and the question. For example, the processor 110 may identify a similarity coefficient between the question and another pair of the table segment and document included in the initial graph (Gd in FIG. 4B).

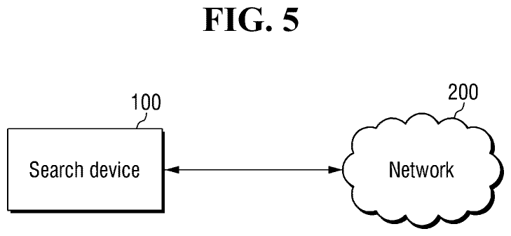

FIG. 5 is a diagram for describing step S200 of FIG. 2.

Referring to FIG. 5, in some embodiments, the search device 100 may communicate with a network 200. The network 200 may be an external network of the search device 100. The network 200 may be, for example, a neural network. The processor 110 may input the question and the initial graph (Gd in FIG. 4B) to the external network 200 and receive a first similarity coefficient from the network 200.

Referring again to FIGS. 1 and 2, the processor 110 may identify a subgraph based on the first similarity coefficients (S300). The subgraph may be a part of the initial graph (Gd in FIG. 4B).

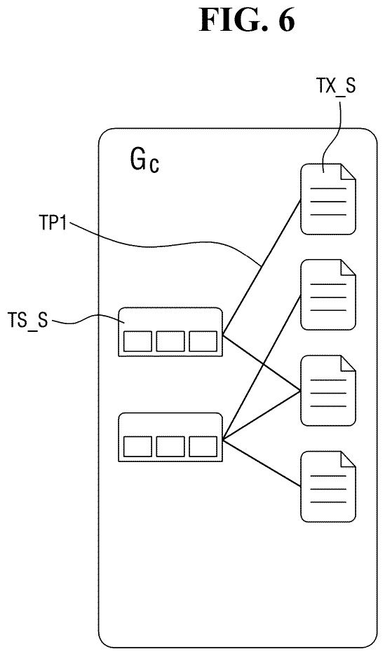

FIG. 6 is a diagram for describing step S300 of FIG. 2.

Referring to FIGS. 4A, 4B and 6, the processor 110 may identify a subgraph Gc that is a part of the initial graph Gd. The subgraph Gc may include at least one tabular data segment TS_S of the subgraph and at least one document TX_S of the subgraph. The subgraph Gc may include at least one pair TP1 of the tabular data segment TS_S of the subgraph and the document TX S of the subgraph.

In some embodiments, the processor 110 may identify the subgraph Gc by identifying the top k (where k is a natural number), with the highest first similarity coefficients, of the plurality of first pairs TP1 of the tabular data segments and documents. For example, the processor 110 may identify the top k pairs of the tabular data segments and documents with the highest first similarity coefficients out of the plurality of first pairs TP1 of the tabular data segments and documents, and identify them as the subgraph Gc. For example, of the nine first pairs TP1 of the tabular data segments and documents of the initial graph Gd, five first pairs TP1 of the tabular data segments and documents may be included in the subgraph Gc. At this time, the processor 110 may identify the subgraph Gc after removing duplicate pairs, if any, of the identified at least one first pair TP1 of the table segment and document.

Referring again to FIGS. 1 and 2, the processor 110 may identify at least one of new tabular data segments and new documents based on the subgraph (S400). The processor 110 may identify at least one of new tabular data segments and new documents that are different from each of the tabular data segments of the subgraph and the documents of the subgraph based on the subgraph.

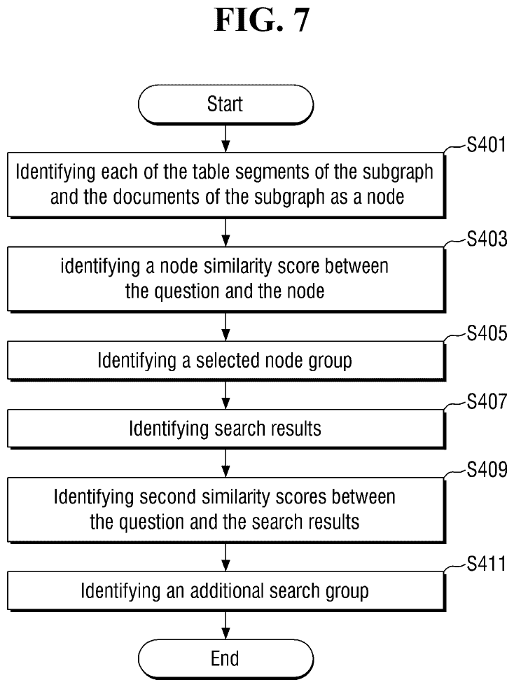

FIG. 7 is a diagram for describing step S400 of FIG. 2.

Referring to FIG. 7, the processor 110 may first identify each of the tabular data segments of the subgraph and the documents of the subgraph as a node (S401) in order to identify at least one of the new tabular data segments and new documents.

The processor 110 may identify a node similarity coefficient between the question and the node (S403). The processor 110 may identify a plurality of node similarity coefficients between each of the plurality of nodes and the question.

In some embodiments, the processor 110 may input the question and the subgraph to the external network (200 in FIG. 5) and receive node similarity coefficients from the external network.

The processor 110 may identify a selected node group (S405). The processor 110 may identify the top k of the node similarity coefficients as the selected node group. The processor 110 may identify the top k nodes with the highest node similarity coefficients as the selected node group. The selected node group may include at least one of the tabular data segments of the subgraph and the documents of the subgraph.

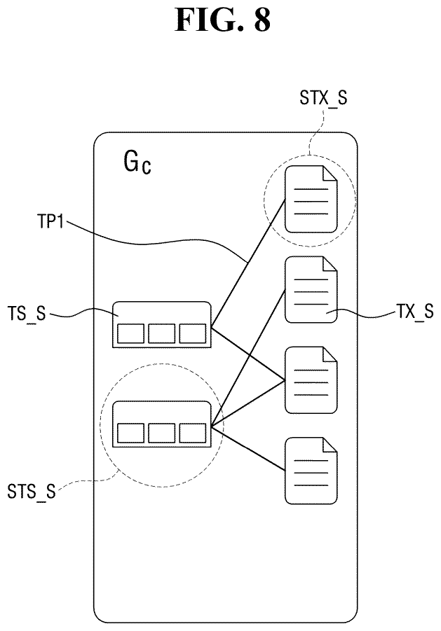

FIG. 8 is a diagram for describing steps S401, S403, and S405 of FIG. 7.

Referring to FIG. 8, the processor 110 may identify each of the tabular data segments TS_S of the subgraph and the documents TX_S of the subgraph included in the subgraph Gc as a node. The processor 110 may identify a node similarity coefficient between the question and each of the plurality of nodes. The processor 110 may identify the top k nodes with the highest node similarity coefficients as a selected node group STS_S and STX S.

Referring again to FIG. 7, the processor 110 may identify search results (S407). The processor 110 may identify search results, which are the results of searching the initial graph Gd for related tabular data segments and related documents that are simultaneously related to the selected node group and the question and are of a different type from the selected node group. The related tabular data segments and related documents may not have been included in the subgraph Gc.

Referring to FIG. 8, for example, if the selected node group includes a selected table segment STS_S, the processor 110 may search the initial graph Gd for related documents of a different type from the selected table segment STS_S and include them in the search results. The related documents may be relevant to the selected table segment STS_S and the question at the same time. In addition, for example, if the selected node group includes a selected document STX_S, the processor 110 may search the initial graph Gd for related tabular data segments that are of a different type from the selected document STX_S and include them in the search results. The related tabular data segments may be relevant to the selected document STX S and the question at the same time.

The search results may include at least one of tabular data segments and documents of a different type from the nodes (e.g., the selected table segment and the selected document) included in the selected node group STS_S and STX S.

Referring again to FIG. 7, the processor 110 may identify second similarity coefficients between the question and the search results (S409). The processor 110 may identify the second similarity coefficients, including a plurality of similarity coefficients between the question and each of the at least one table segment and document included in the search results.

In some embodiments, the processor 110 may input the question and the search results to an external network (200 in FIG. 5) and receive the second similarity coefficients from the external network.

The processor 110 may identify an additional search group based on the second similarity coefficients (S411).

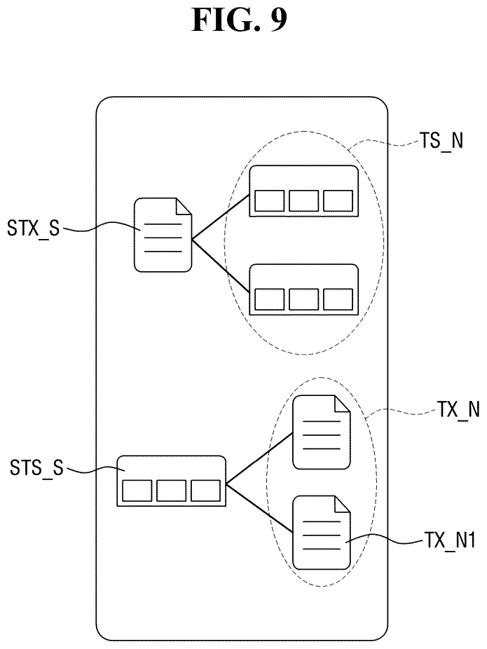

FIG. 9 is a diagram for describing step S411 of FIG. 7.

Referring to FIG. 9, the processor 110 may identify an additional search group TS_N and TX_N by identifying the top k, with the highest second similarity coefficients, of the search results. The additional search group TS_N and TX_N may include at least one of new tabular data segments TS_N and new documents TX N.

In FIG. 9, the additional search group TS_N and TX_N may include two new tabular data segments TS_N and two new documents TX N. The new tabular data segments TS_N may be the result of selecting k ones with the highest second similarity coefficients after the ones that are relevant to the selected document STX_S and the question and are of a non-document type are searched in the initial graph Gd. The new documents TX_N may be the result of selecting k ones with the highest second similarity coefficients after the ones that are relevant to the selected table segment STS_S and the question and are of a non-table segment type are searched in the initial graph Gd.

For example, the processor 110 may search the initial graph Gd for a plurality of documents related to both the selected table segment STS_S in the selected node group STS_S and STX_S and the question and identify them. The processor 110 may identify the second similarity coefficients, including similarity coefficients between the plurality of documents in the search results and the question. The processor 110 may identify new documents TX_N to be included in the additional search group by identifying the top k ones with the highest second similarity coefficients.

For example, the processor 110 may search the initial graph Gd for a plurality of tabular data segments related to both the selected document STX_S in the selected node group STS_S and STX_S and the question and identify them. The processor 110 may identify the second similarity coefficients, including similarity coefficients between the plurality of tabular data segments in the search results and the question. The processor 110 may identify new tabular data segments TS_N to be included in the additional search group by identifying the top k ones with the highest second similarity coefficients.

The additional search group TS_N and TX_N may consist of tabular data segments and/or documents that were not included in the subgraph Gc.

Referring again to FIGS. 1 and 2, the processor 110 may identify at least one second pair of a table segment and a document (S500). The at least one second pair of the table segment and document may be at least a part of the new tabular data segments and the new documents.

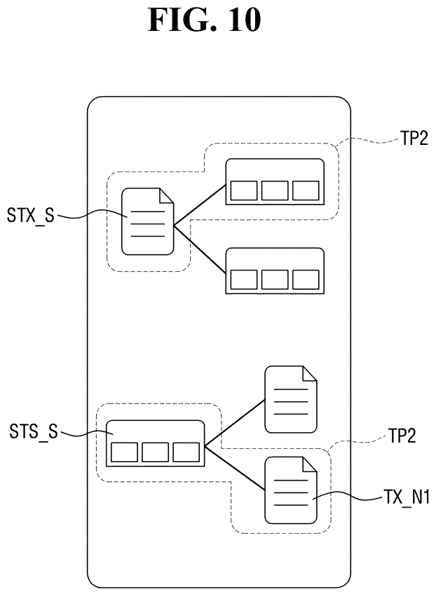

FIG. 10 is a diagram for describing step S500 of FIG. 2.

Referring to FIG. 10, the processor 110 may identify at least one second pair TP2 of the table segment and document, which is a part of pairs of the tabular data segments and documents in FIG. 9.

The processor 110 may identify a third similarity coefficient for each of the new tabular data segments TX_N and the new documents TX_N based on the node similarity coefficient and the second similarity coefficient. For example, the processor 110 may identify the third similarity coefficient by multiplying the node similarity coefficient and the second similarity coefficient. For example, the processor 110 may identify a third similarity coefficient for a pair of a selected table segment STS_S and a first new document TX_N by multiplying the node similarity coefficient of the selected table segment STS_S by the second similarity coefficient between the pair of the selected table segment STS_S and the first new document TX_N1 and the question.

The processor 110 may identify at least one second pair TP2 of the table segment and document based on the third similarity coefficient. The processor 110 may identify the top k ones, with the highest third similarity coefficients with the paired selected node group STS_S and STX_S, of the additional search group TX_N and TS_N as the at least one second pair TP2 of the table segment and document.

In FIG. 10, for example, two pairs TP2 with the highest third similarity coefficients may be identified out of four pairs of tabular data segments and documents.

Referring again to FIGS. 1 and 2, the processor 110 may identify a modified graph (S600). The processor 110 may identify a modified graph by adding the at least one second pair of the table segment and document (TP2 in FIG. 10) to the subgraph (Gc in FIG. 8).

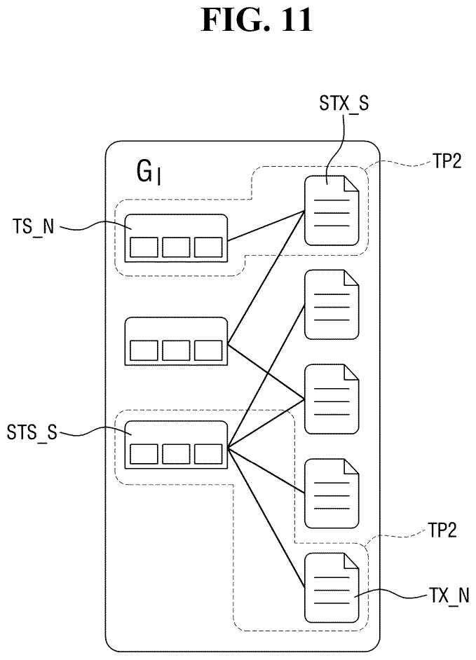

FIG. 11 is a diagram for describing step S600 of FIG. 2.

Referring to FIG. 11, the processor 110 may identify a modified graph Gl by adding the at least one second pair TP2 of the table segment and document to the subgraph (Gc in FIG. 8).

The modified graph Gl may include modified tabular data segments and modified documents. The modified tabular data segments may include a table segment of the subgraph Gc and a second table segment of the at least one second pair TP2 of the table segment and document. The modified documents may include a document of the subgraph Gc and a second document of the at least one second pair TP2 of the table segment and document.

Referring again to FIGS. 1 and 2, the processor 110 may identify an expanded graph (S700). The processor 110 may identify an expanded graph obtained by modifying the modified graph based on the modified graph (Gl in FIG. 11).

The processor 110 may identify an expanded result graph based on the relevance between the expanded graph and the question (S800).

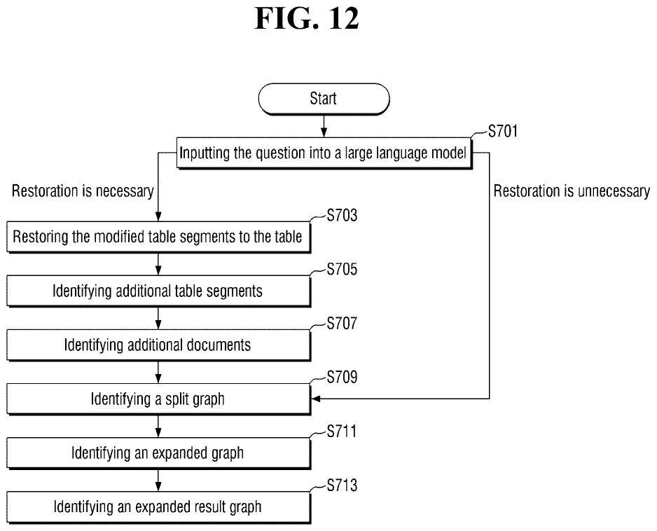

FIG. 12 is a diagram for describing step S700 and step S800 of FIG. 2.

Referring to FIG. 12, the processor 110 may first input the question into a large language model (S701) in order to modify the modified graph and identify the expanded graph. The processor 110 may input the question into the large language model and receive a result from the large language model as to whether it is necessary to reconstruct the original table (tabular data) (OT in FIG. 3) with the modified tabular data segments included in the modified graph Gl. The modified tabular data segments may be the result of dividing, around rows, the table containing a plurality of rows.

If the reconstruction is necessary, the processor 110 may reconstruct the table with the modified tabular data segments (S703). The processor 110 may reconstruct the original table (OT in FIG. 3) with each of the modified tabular data segments of FIG. 11.

The processor 110 may identify additional tabular data segments (S705). The processor 110 may identify additional tabular data segments relevant to the question in the reconstructed table.

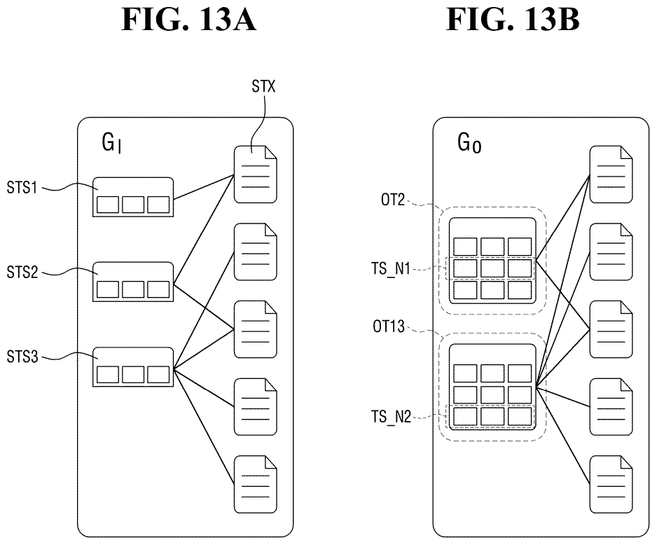

FIGS. 13A and 13B are example diagrams for describing steps S703 and S705 of FIG. 12. The modified graph Gl in FIG. 13A is the same as the modified graph Gl in FIG. 11.

Referring to FIG. 13A, the modified graph Gl may include a first modified table segment STS1, a second modified table segment STS2, and a third modified table segment STS3. The modified graph Gl may include a plurality of modified documents STX that are paired with each of the modified tabular data segments STS1, STS2, and STS3.

The processor 110 may reconstruct the original table with each of the modified tabular data segments STS1, STS2, and STS3, based on the reconstruction being necessary. The example in FIG. 13B may be a case where some of the modified tabular data segments STS1, STS2, and STS3 have been split from the same table. In this case, there are three modified tabular data segments STS1, STS2, and STS3, but fewer than three tabular data may be identified after the reconstruction. For example, if the first modified table segment STS1 and the third modified table segment STS3 have been split from the same table, two identical original tabular data will be identified when each of the first modified table segment STS1 and the third modified table segment STS3 is used for reconstruction, and a duplicate table can thus be removed. As a result, the reconstructed modified graph Go in FIG. 13B may include a reconstructed first table OT13. The processor 110 may identify a reconstructed second table OT2 of the reconstructed modified graph Go in FIG. 13B by reconstructing with the second modified table segment STS2.

The processor 110 may identify additional tabular data segments TS_N1 and TS_N2 relevant to the question out of the reconstructed tables OT13 and OT2. The additional tabular data segments TS_N1 and TS_N2 may be tabular data segments that are the same as or different from the modified tabular data segments STS1, STS2, and STS3.

In some embodiments, the processor 110 may identify additional tabular data segments TS_N1 and TS_N2 by inputting the reconstructed modified graph Go and the question into the large language model and receiving the additional tabular data segments TS_N1 and TS_N2 relevant to the question from the large language model.

Referring again to FIG. 12, the processor 110 may identify additional documents (S707). The processor 110 may identify additional documents related to the additional tabular data segments (TS_N1 and TS_N2 in FIG. 13B) by searching for the additional tabular data segments (TS_N1 and TS_N2 in FIG. 13B) in one of the modified graph (Gl in FIG. 13A) and the initial graph (Gd in FIG. 4B).

If the additional tabular data segments (TS_N1 and TS_N2 in FIG. 13B) are present in the modified graph (Gl in FIG. 13A), the processor 110 may search for related additional documents in the modified graph (Gl in FIG. 13A). If the additional tabular data segments (TS_N1 and TS_N2 in FIG. 13B) are not present in the modified graph (Gl in FIG. 13A), the processor 110 may search for related additional documents in the initial graph (Gd in FIG. 4B).

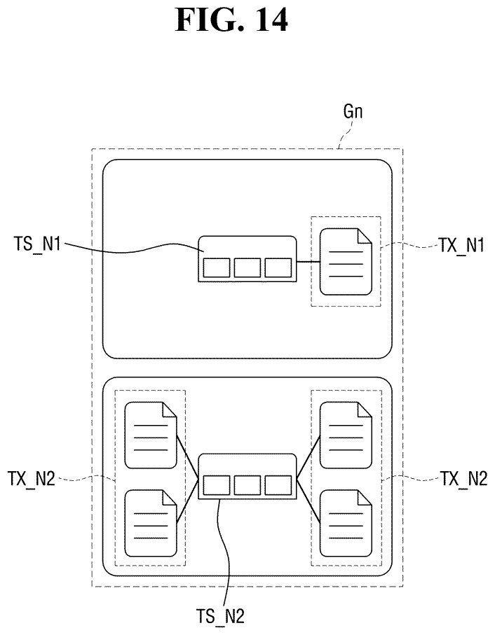

FIG. 14 is a diagram for describing step S707 of FIG. 12.

Referring to FIG. 14, the processor 110 may identify a first additional document TX_N1 related to a first additional tabular data segment TS_N1 identified in the reconstructed modified graph Go in FIG. 13B. The processor 110 may identify a second additional document TX_N2 related to a second additional tabular data segment TS_N2 identified in the reconstructed modified graph Go in FIG. 13B.

An additional graph Gn may include subgraphs (e.g., a star graph) organized around tabular data segments. For example, the additional graph Gn may include one subgraph in which the first additional tabular data segment TS_N1 and the first additional document TX_N1 related thereto are paired, and another subgraph in which the second additional tabular data segment TS_N2 and the second additional document TX_N2 related thereto are paired. The subgraphs may have overlaps, for example, in which one additional document is paired with both the first additional tabular data segment TS_N1 and the second additional tabular data segment TS_N2.

Referring again to FIG. 12, the processor 110 may identify a split graph (S709). The processor 110 may identify the split graph by splitting the modified graph (Gl in FIG. 13A) around the modified tabular data segments STS1, STS2, and STS3.

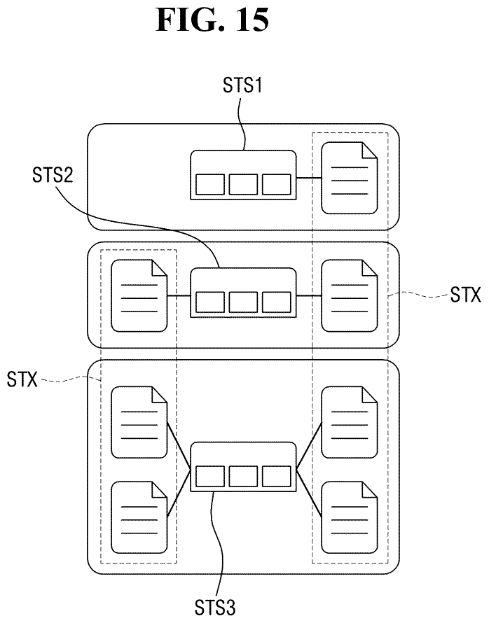

FIG. 15 is a diagram for describing step S709 of FIG. 12.

Referring to FIG. 15, the processor 110 may split the modified graph (Gl in FIG. 13A) around the modified tabular data segments STS1, STS2, and STS3 of the modified graph (Gl in FIG. 13A). In the case of the example in FIG. 15, since there are three modified tabular data segments STS1, STS2, and STS3, a split graph including three subgraphs may be identified. The split graph may include a modified document STX related to each of the modified tabular data segments STS1, STS2, and STS3.

Referring again to FIG. 12, the processor 110 may identify an expanded graph (S711). The processor 110 may identify the expanded graph based on the split graph (graph in FIG. 15) and the additional graph (Gn in FIG. 14). The additional graph (Gn in FIG. 14) may include additional tabular data segments (TS_N1 and TS_N2 in FIG. 14) and additional documents (TX_N1 and TX_N2 in FIG. 14).

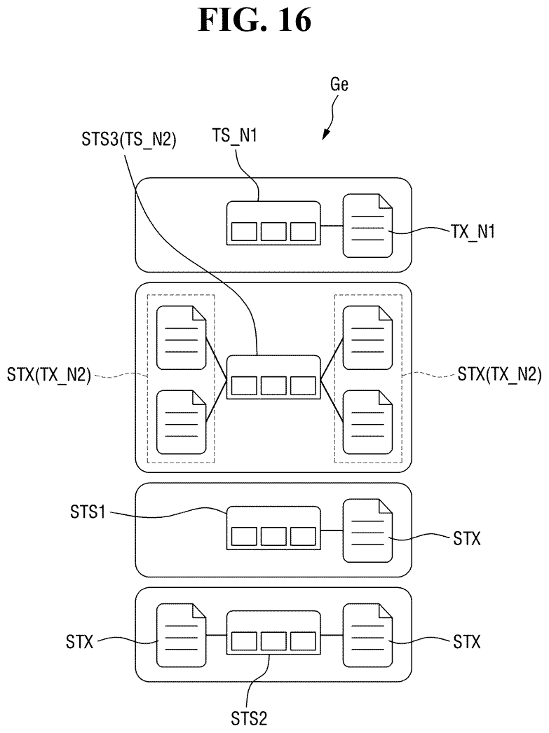

FIG. 16 is a diagram for describing step S711 of FIG. 12.

Referring to FIG. 16, the processor 110 may identify the expanded graph Ge by removing duplicate segments and documents in the split graph (graph in FIG. 15) and the additional graph (Gn in FIG. 14). For example, if the second additional tabular data segment TS_N2 and the third modified table segment STS3 are duplicates of each other in the split graph (graph in FIG. 15) and the additional graph (Gn of FIG. 14), the graphs for each of the second additional tabular data segment TS_N2 and the third modified table segment STS3 may be combined into one.

Referring again to FIG. 12, the processor 110 may identify an expanded result graph (S713). The processor 110 may identify the expanded result graph by removing pairs of tabular data segments and documents that are not relevant (or less relevant) to the question from the expanded graph (Ge in FIG. 16).

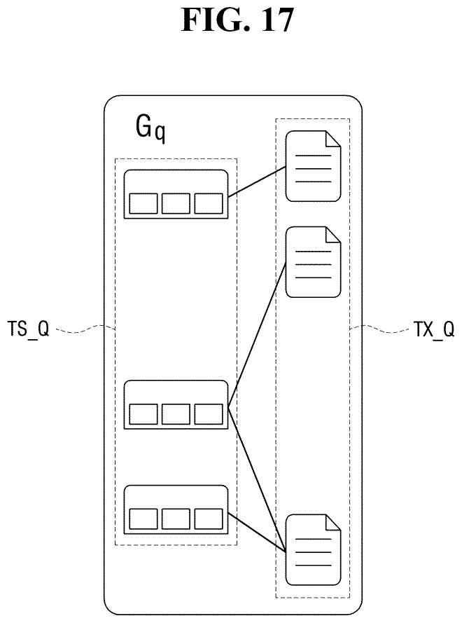

FIG. 17 is a diagram for describing step S713 of FIG. 12.

Referring to FIG. 17, the processor 110 may identify an expanded result graph Gq that includes result tabular data segments TS_Q and result documents TX_Q. The expanded result graph Gq may be the one obtained by removing the pairs of tabular data segments and documents that are not relevant (or less relevant) to the question from the expanded graph Ge of FIG. 16.

In some embodiments, the processor 110 may input the question and the expanded graph (Ge in FIG. 16) into the large language model, and receive from the large language model the expanded result graph Gq in which the pairs of tabular data segments and documents that are not relevant (or less relevant) to the question have been removed.

The expanded result graph Gq may have tabular data segments and documents added and/or deleted compared to the subgraph (Gc in FIG. 6). For example, even for a document that has been selected in the subgraph (Gc in FIG. 6), it may be determined to be less relevant to the question and may thus be deleted from the expanded result graph Gq. In addition, for example, even for a table segment that has not been selected in the subgraph (Gc in FIG. 6), it may be determined to be highly relevant to the question and may thus be added to the expanded result graph Gq.

Referring again to FIG. 12, if the reconstruction is not necessary, the processor 110 may identify the split graph (S709) without reconstructing the table with the modified tabular data segments. The processor 110 may identify the expanded graph (Ge in FIG. 16) (S711) by removing duplicate segments and documents in the split graph (graph in FIG. 15). The processor 110 may identify the expanded result graph (Gq in FIG. 17) (S713) by removing pairs of tabular data segments and documents that are not relevant (or less relevant) to the question from the expanded graph (Ge in FIG. 16).

Referring again to FIGS. 1 and 2, the processor 110 may identify final similarity coefficients (S900). The processor 110 may identify final similarity coefficients between the question and pairs of result tabular data segments and documents included in the expanded result graph (Gq in FIG. 17).

The processor 110 may identify a final graph based on the final similarity coefficients (S1000). The processor 110 may identify a final graph in which the pairs of the result tabular data segments and documents are sorted based on the final similarity coefficients. The pairs of the result tabular data segments and documents of the final graph may be sorted in descending order of the final similarity coefficients.

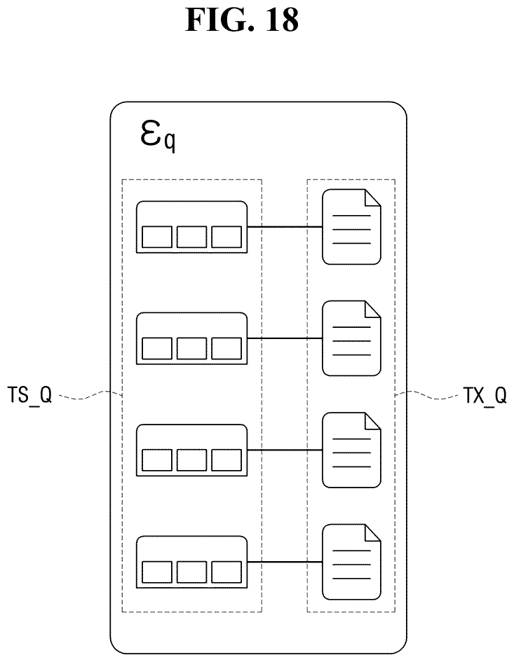

FIG. 18 is a diagram for describing step S900 and step S1000 of FIG. 2.

Referring to FIG. 18, the processor 110 may identify a final graph Eq in which the expanded result graph Gq of FIG. 17 is sorted based on the final similarity coefficients.

In some embodiments, the processor 110 may input the question and the expanded result graph (Gq in FIG. 17) into the large language model, and receive the final graph sorted in descending order of the final similarity coefficients from the large language model.

The processor 110 may identify and provide the final graph as an answer to the question.

The search device according to embodiments of the present disclosure can identify tabular data and/or documents highly relevant to a question that have not been found in the subgraph Gc by identifying the final graph Eq from the subgraph Gc that is a partial graph selected in the initial graph Gd by taking into account the relevance to the question through the steps of FIG. 2 (S400, S500, S600, S700, S800, S900, and S1000), and can provide answer results highly relevant to the question by removing the tabular data segments and/or documents that have been found despite having low relevance to the question from the subgraph Gc.

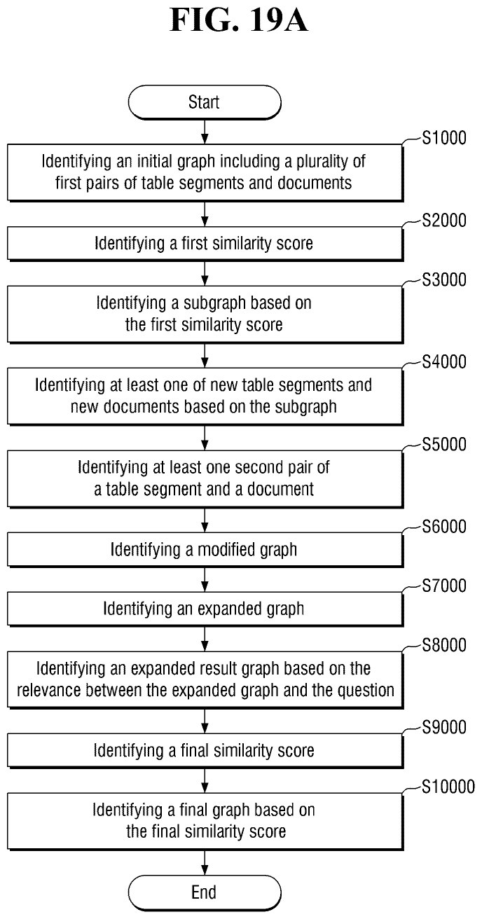

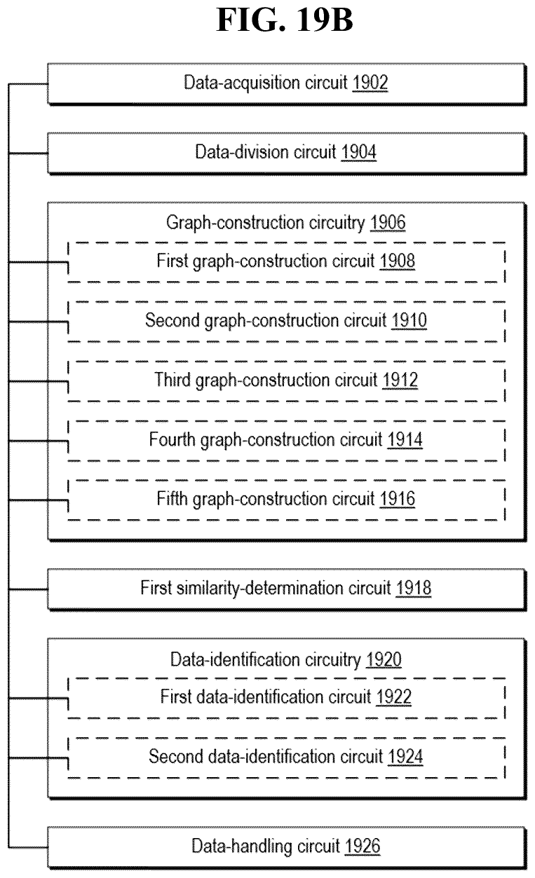

Hereinafter, a technology-integrated method in accordance with embodiments of the present disclosure will be described with reference to FIG. 19A. For clarity of description, any parts that overlap with what has been described above will be simplified or omitted.

FIG. 19A is a flowchart for describing a technology-integrated method in accordance with an embodiment of the present disclosure.

Referring to FIG. 19A, the technology-integrated method in accordance with an embodiment of the present disclosure may include identifying an initial graph including a plurality of first pairs of tabular data segments and documents (S1000). The initial graph may be formed, for example, in an early fusion method.

The technology-integrated method in accordance with an embodiment of the present disclosure may include identifying a first similarity coefficient (S2000).

The technology-integrated method in accordance with an embodiment of the present disclosure may include identifying a subgraph based on the first similarity coefficient (S3000). Of the plurality of first pairs of tabular data segments and documents, the top k ones with the highest first similarity coefficients may be identified as the subgraph.

The technology-integrated method in accordance with an embodiment of the present disclosure may include identifying at least one of new tabular data segments and new documents based on the subgraph (S4000).

The identifying the at least one of the new tabular data segments and the new documents (S4000) may include identifying each of the tabular data segments of the subgraph and the documents of the subgraph as a node. The identifying the at least one of the new tabular data segments and the new documents (S4000) may include identifying node similarity coefficients between a question and the nodes, after the nodes are identified.

The identifying the at least one of the new tabular data segments and the new documents (S4000) may include identifying a selected node group by identifying the top k (where k is a natural number), with the highest node similarity coefficients, of the nodes.

The identifying the at least one of the new tabular data segments and the new documents (S4000) may include identifying search results, which are the results of searching the initial graph for new tabular data segments and new documents that are simultaneously related to the selected node group and the question and are of a different type from the selected node group.

The identifying the at least one of the new tabular data segments and the new documents (S4000) may include identifying second similarity coefficients between the question and the search results.

The identifying the at least one of the new tabular data segments and the new documents (S4000) may include identifying an additional search group by identifying the top k, with the highest second similarity coefficients, of the search results. The additional search group may include at least one of the new tabular data segments and the new documents.

The technology-integrated method in accordance with an embodiment of the present disclosure may include identifying at least one second pair of a table segment and a document (S5000). The at least one second pair of the table segment and document may be at least a part of the new tabular data segments and the new documents. The at least one second pair of the table segment and document may be identified based on a third similarity coefficient for each of the new tabular data segments and the new documents. The third similarity coefficient may be calculated based on the node similarity coefficient and the second similarity coefficient.

The technology-integrated method in accordance with an embodiment of the present disclosure may include identifying a modified graph (S6000). The modified graph may be identified by adding the at least one second pair of the table segment and document to the subgraph.

The technology-integrated method in accordance with an embodiment of the present disclosure may include identifying an expanded graph (S7000).

The identifying the expanded graph (S7000) may include inputting the question into a large language model. The identifying the expanded graph (S7000) may include receiving whether reconstruction is necessary for modified tabular data segments from the large language model.

The identifying the expanded graph (S7000) may include reconstructing the original table with the modified tabular data segments based on the reconstruction being necessary. The identifying the expanded graph (S7000) may include identifying additional tabular data segments relevant to the question in the table. The identifying the expanded graph (S7000) may include identifying additional documents related to the additional tabular data segments by searching for the additional tabular data segments in one of the modified graph and the initial graph. The identifying the expanded graph (S7000) may include identifying a split graph by splitting the modified graph around the modified tabular data segments. The identifying the expanded graph (S7000) may include identifying the expanded graph based on the split graph, the additional tabular data segments, and the additional documents.

If the reconstruction is not necessary, the identifying the expanded graph (S7000) may include identifying the expanded graph by removing duplicate pairs of the tabular data segments and documents in the split graph.

The technology-integrated method in accordance with an embodiment of the present disclosure may include identifying an expanded result graph based on the relevance between the expanded graph and the question (S8000). The expanded result graph may be identified based on the relevance between the expanded graph and the question.

The technology-integrated method in accordance with an embodiment of the present disclosure may include identifying final similarity coefficients (S9000).

The technology-integrated method in accordance with an embodiment of the present disclosure may include identifying a final graph based on the final similarity coefficients (S10000). In the final graph, pairs of result tabular data segments and documents included in the expanded result graph may be sorted in descending order of the final similarity coefficients.

The technology-integrated method in accordance with an embodiment of the present disclosure may include providing the final graph as an answer to the question.

FIG. 19B is an example circuit diagram for implementing a technology-integrated apparatus. Each of the illustrated circuits includes a respective plurality of transistors configured to implement one or more respective operations associated with the respective circuit. The circuits may further include resistors and capacitors.

Referring to FIG. 19B, the technology-integrated apparatus in accordance with an embodiment of the present disclosure may include a data-acquisition circuit 1902. In some embodiments, the data-acquisition circuit is configured to acquire tabular data organized into rows and a query for querying the tabular data.

The technology-integrated apparatus in accordance with an embodiment of the present disclosure may include a data-division circuit 1904. In some embodiments, the data-division circuit 1904 is configured to divide the tabular data into tabular data segments each including one or more of the rows.

The technology-integrated apparatus in accordance with an embodiment of the present disclosure may include graph-construction circuitry 1906, such as one or more of the illustrated first to fifth graph-construction circuits 1908, 1910, 1912, 1914, and 1916. In some embodiments, the first graph-construction circuit 1908 is configured to construct an initial graph including first pairs of tabular data segments and documents relating to the tabular data segments. In some embodiments, the second graph-construction circuit 1910 is configured to construct a subgraph that is part of the initial graph based on a first similarity coefficient. In some embodiments, the third graph-construction circuit 1912 is configured to construct a modified graph by adding at least one second pair of the tabular data segment and document to the subgraph. In some embodiments, the fourth graph-construction circuit 1914 is configured to construct an expanded graph by modifying the modified graph based on the modified graph. In some embodiments, the fifth graph-construction circuit 1916 is configured to construct an expanded result graph based on relevance between the expanded graph and the query.

The technology-integrated apparatus in accordance with an embodiment of the present disclosure may include a first similarity-determination circuit 1918. In some embodiments, the first similarity-determination circuit 1918 is configured to determine first similarity coefficients between the query and each of the first pairs of the tabular data segments and documents.

The technology-integrated apparatus in accordance with an embodiment of the present disclosure may include data-identification circuitry 1920, such as one or more of the illustrated first and second data-identification circuits 1922 and 1924. In some embodiments, the first data-identification circuit 1922 is configured to identify, based on the subgraph, at least one of new tabular data segments and new documents that are different from each of the tabular data segments of the subgraph and the documents of the subgraph included in the subgraph. In some embodiments, the second data-identification circuit 1924 is configured to identify at least one second pair of a tabular data segment and a document, which is at least part of the new tabular data segments and the new documents.

The technology-integrated apparatus in accordance with an embodiment of the present disclosure may include a data-handling circuit 1926. In some embodiments, the data-handling circuit 1926 is configured to store one or more of the expanded graph and the expanded result graph. In some embodiments, the data-handling circuit 1926 is configured to transmit one or more of the expanded graph and the expanded result graph.

In one or more examples, the operations described in reference to FIGS. 1 to 19A may be performed by the circuitry and circuits illustrated in FIG. 19B as well as additional circuitry and circuits. In one or more examples, a processor includes the circuits described herein. The circuits may be encoded with instructions to perform the respective functions or operations. The circuits may be an integrated circuit.

Various examples and aspects of the present disclosure are described below. These are provided as examples, and they do not limit the scope of the present disclosure.

In one or more aspects, an electronic device for determining semantic correlations between structured data and unstructured data and data retrieval in response to queries, includes a data-acquisition circuit configured to acquire tabular data organized into rows and a query for querying the tabular data. The electronic device also includes a data-division circuit configured to divide the tabular data into tabular data segments each comprising one or more of the rows. Additionally, the electronic device includes a first graph-construction circuit configured to construct an initial graph comprising first pairs of tabular data segments and documents relating to the tabular data segments. Further, the electronic device includes a first similarity-determination circuit configured to determine first similarity coefficients between the query and each of the first pairs of the tabular data segments and documents. Moreover, the electronic device includes a second graph-construction circuit configured to construct a subgraph that is part of the initial graph based on the first similarity coefficients. Furthermore, the electronic device includes a first data-identification circuit configured to identify, based on the subgraph, at least one of new tabular data segments and new documents that are different from each of the tabular data segments of the subgraph and the documents of the subgraph included in the subgraph. Additionally, the electronic device includes a second data-identification circuit configured to identify at least one second pair of a tabular data segment and a document which is at least part of the new tabular data segments and the new documents. Further, the electronic device includes a third graph-construction circuit configured to construct a modified graph by adding the at least one second pair of the tabular data segment and the document to the subgraph. Moreover, the electronic device includes a fourth graph-construction circuit configured to construct an expanded graph by modifying the modified graph based on the modified graph. Furthermore, the electronic device includes a fifth graph-construction circuit configured to construct an expanded result graph based on relevance between the expanded graph and the query. Additionally, the electronic device includes a data-handling circuit configured to store or transmit one or more of the expanded graph and the expanded result graph.

In one or more aspects of the aforenoted electronic device, the first graph-construction circuit is further configured to construct the initial graph being formed in an early fusion method.

In one or more aspects of an aforenoted electronic device, the electronic device further includes a data-processing circuit configured to provide the query and the initial graph to an external network and further configured to receive the first similarity coefficients from the external network.

In one or more aspects of an aforenoted electronic device, the second graph-construction circuit is further configured to construct the subgraph by identifying top k (where k is a natural number) of the first pairs of the tabular data segments and documents with highest of the first similarity coefficients.

In one or more aspects of an aforenoted electronic device, the electronic device further includes a node-construction circuit configured to construct each of the tabular data segments of the subgraph and the documents of the subgraph as a node. The electronic device also includes a second similarity-determination circuit configured to determine node similarity coefficients between the query and the nodes. Additionally, the electronic device includes a third data-identification circuit configured to identify a selected node group by identifying top k (where k is a natural number) of the nodes with highest of the node similarity coefficients.

In one or more aspects of an aforenoted electronic device, the electronic device further includes a fourth data-identification circuit configured to identify search results that are a result of searching the initial graph for related tabular data segments and related documents that are simultaneously related to the selected node group and the query and are of a different type from the selected node group. The electronic device also includes a third similarity-determination circuit configured to determine second similarity coefficients between the query and the search results. Additionally, the electronic device includes a fifth data-identification circuit configured to identify an additional search group by identifying top k of the search results with highest of the second similarity coefficients. In such aspects, the additional search group comprises at least one of the new tabular data segments and the new documents.

In one or more aspects of an aforenoted electronic device, the electronic device further includes a sixth data-identification circuit configured to identify a third similarity coefficient for each of the new tabular data segments and the new documents. In such aspects, the second data-identification circuit is further configured to identify the at least one second pair of the tabular data segment and the document based on the third similarity coefficient.

In one or more aspects of an aforenoted electronic device, the sixth data-identification circuit is further configured to identify the third similarity coefficients based on the node similarity coefficients and the second similarity coefficients. Additionally, in such aspects, the second data-identification circuit is further configured to identify the at least one second pair of the tabular data segment and the document by identifying top k of the additional search group with highest of the third similarity coefficients.

In one or more aspects of an aforenoted electronic device, the modified graph comprises the tabular data segments of the subgraph, the documents of the subgraph, a second tabular data segment of the at least one second pair of the tabular data segment and the document, and a second document of the at least one second pair of the tabular data segment and the document. Additionally, in such aspects, the tabular data segments of the subgraph and the second tabular data segment are modified tabular data segments. Further, in such aspects, the documents of the subgraph and the second document are modified documents. Moreover, in such aspects, the electronic device further includes a data-forwarding circuit configured to provide the query to a large language model and receive an indication from the large language model indicating whether reconstruction is necessary for the modified tabular data segments. Furthermore, in such aspects, the electronic device further includes a data-reconstruction circuit configured to reconstruct the tabular data with the modified tabular data segments based on the reconstruction being necessary. Additionally, in such aspects, the electronic device includes a seventh data-identification circuit configured to identify additional tabular data segments relevant to the query in the tabular data. Further, in such aspects, the electronic device includes an eighth data-identification circuit configured to identify additional documents related to the additional tabular data segments by searching for the additional tabular data segments in one of the modified graph and the initial graph. Moreover, in such aspects, the electronic device includes a sixth graph-construction circuit configured to construct a split graph by splitting the modified graph around the modified tabular data segments. Furthermore, in such aspects, the fourth graph-construction circuit is further configured to construct the expanded graph based on the split graph, the additional tabular data segments, and the additional documents.

In one or more aspects of an aforenoted electronic device, the fifth graph-construction circuit is further configured to construct the expanded result graph by removing pairs of tabular data segments and documents that are not relevant to the query in the expanded graph.

In one or more aspects of an aforenoted electronic device, the fifth graph-construction circuit is further configured to construct the expanded result graph by removing duplicate pairs of tabular data segments and documents in the split graph based on the reconstruction being unnecessary.

In one or more aspects of an aforenoted electronic device, the fifth graph-construction circuit is further configured to construct the expanded result graph by removing pairs of tabular data segments and documents that are not relevant to the query in the expanded graph.

In one or more aspects of an aforenoted electronic device, the electronic device further includes a fourth similarity-determination circuit configured to determine final similarity coefficients between the query and pairs of result tabular data segments and documents included in the expanded result graph. The electronic device also includes a seventh graph-construction circuit configured to construct a final graph in which the pairs of the result tabular data segments and documents are sorted based on the final similarity coefficients.

In one or more aspects of an aforenoted electronic device, the data-handling circuit is further configured to present the final graph as responsive to the query.

In one or more aspects, a computer-implemented method for determining semantic correlations between structured data and unstructured data and data retrieval in response to queries, includes acquiring tabular data organized into rows and a query for querying the tabular data. In an example, a query may include a question. The computer-implemented method also includes dividing the tabular data into tabular data segments each comprising one or more of the rows. Additionally, the computer-implemented method includes constructing an initial graph comprising first pairs of tabular data segments and documents relating to the tabular data segments. In an example, a tabular data segment may include a table segment. Further, the computer-implemented method includes determining first similarity coefficients between the query and each of the first pairs of the tabular data segments and documents. In an example, a similarity coefficient may include a similarity coefficient. Moreover, the computer-implemented method includes constructing a subgraph that is part of the initial graph based on the first similarity coefficients. Furthermore, the computer-implemented method includes identifying, based on the subgraph, at least one of new tabular data segments and new documents that are different from each of the tabular data segments of the subgraph and the documents of the subgraph included in the subgraph. Additionally, the computer-implemented method includes identifying at least one second pair of a tabular data segment and a document, which is at least part of the new tabular data segments and the new documents. Further, the computer-implemented method includes constructing a modified graph by adding the at least one second pair of the tabular data segment and the document to the subgraph. Moreover, the computer-implemented method includes constructing an expanded graph by modifying the modified graph based on the modified graph. Furthermore, the computer-implemented method includes constructing an expanded result graph based on relevance between the expanded graph and the query. Additionally, the computer-implemented method includes storing or transmitting one or more of the expanded graph and the expanded result graph.

In one or more aspects of the aforenoted computer-implemented method, the identifying the at least one of the new tabular data segments and the new documents comprises constructing each of the tabular data segments of the subgraph and the documents of the subgraph as a node. In such aspects, the identifying further includes determining node similarity coefficients between the query and the nodes. Additionally, in such aspects, the identifying further includes identifying a selected node group by identifying top k (where k is a natural number) of the nodes with highest of the node similarity coefficients.

In one or more aspects of an aforenoted computer-implemented method, the identifying the at least one of the new tabular data segments and the new documents comprises identifying search results that are a result of searching the initial graph for the new tabular data segments and the new documents that are simultaneously related to the selected node group and the query and are of a different type from the selected node group. In such aspects, the identifying further includes determining second similarity coefficients between the query and the search results. Additionally, in such aspects, the identifying further includes identifying an additional search group by identifying top k of the search results with highest of the second similarity coefficients. In such aspects, the additional search group comprises at least one of the new tabular data segments and the new documents.

In one or more aspects of an aforenoted computer-implemented method, the modified graph comprises the tabular data segments of the subgraph, the documents of the subgraph, a second tabular data segment of the at least one second pair of the tabular data segment and the document, and a second document of the at least one second pair of the tabular data segment and the document. In such aspects, the tabular data segments of the subgraph and the second tabular data segment are modified tabular data segments. Additionally, in such aspects, the documents of the subgraph and the second document are modified documents. Further, in such aspects, the identifying the expanded graph includes: inputting the query into a large language model; receiving an indication, from the large language model, indicating whether reconstruction is necessary for the modified tabular data segments; reconstructing the tabular data with the modified tabular data segments, based on the reconstruction being necessary; identifying additional tabular data segments relevant to the query in the tabular data; identifying additional documents related to the additional tabular data segments by searching for the additional tabular data segments in one of the modified graph and the initial graph; constructing a split graph by splitting the modified graph around the modified tabular data segments; and constructing the expanded graph based on the split graph, the additional tabular data segments, and the additional documents.

In one or more aspects of an aforenoted computer-implemented method, the constructing the expanded graph includes constructing the expanded graph by removing duplicate pairs of tabular data segments and documents in the split graph, based on the reconstruction being unnecessary.

In one or more aspects of an aforenoted computer-implemented method, the computer-implemented method further includes determining final similarity coefficients between the query and pairs of result tabular data segments and documents included in the expanded result graph. In such aspects, the computer-implemented method further includes constructing a final graph in which the pairs of the result tabular data segments and documents are sorted based on the final similarity coefficients. Additionally, in such aspects, the computer-implemented method further includes presenting the final graph responsive to the query.

According to some aspects of the disclosure, a search device for tables and documents according to a question, comprises: a processor, and a memory operatively coupled to the processor, wherein the memory stores instructions that, when executed, cause the processor to: identify tabular data segments obtained by dividing the table based on rows, identify an initial graph comprising a plurality of first pairs of tabular data segments and documents in which the tabular data segments and documents related to the tabular data segments are paired, identify a first similarity coefficient between the question and each of the plurality of first pairs of the tabular data segments and documents, identify a subgraph that is part of the initial graph based on the first similarity coefficients, identify at least one of new tabular data segments and new documents that are different from each of the tabular data segments of the subgraph and the documents of the subgraph included in the subgraph based on the subgraph, identify at least one second pair of the table segment and document, which is at least part of the new tabular data segments and the new documents, identify a modified graph by adding the at least one second pair of the table segment and document to the subgraph, identify an expanded graph obtained by modifying the modified graph, based on the modified graph, and identify an expanded result graph based on relevance between the expanded graph and the question.

According to some aspects, the instructions cause the processor to: identify the initial graph formed in an early fusion method.

According to some aspects, the instructions cause the processor to: input the question and the initial graph to an external network, and receive the first similarity coefficients from the external network.

According to some aspects, the instructions cause the processor to: identify the subgraph by identifying top k (where k is a natural number), with the highest first similarity coefficients, of the plurality of first pairs of the tabular data segments and documents.

According to some aspects, the instructions cause the processor to: identify each of the tabular data segments of the subgraph and the documents of the subgraph as a node, identify node similarity coefficients between the question and the nodes, and identify a selected node group by identifying top k (where k is a natural number), with the highest node similarity coefficients, of the nodes.

According to some aspects, the instructions cause the processor to: identify search results that are a result of searching the initial graph for related tabular data segments and related documents that are simultaneously related to the selected node group and the question and are of a different type from the selected node group, identify second similarity coefficients between the question and the search results, and identify an additional search group by identifying top k, with the highest second similarity coefficients, of the search results, and wherein the additional search group comprises at least one of the new tabular data segments and the new documents.

According to some aspects, the instructions cause the processor to: identify a third similarity coefficient for each of the new tabular data segments and the new documents, and identify the at least one second pair of the table segment and document based on the third similarity coefficient.

According to some aspects, the instructions cause the processor to: identify the third similarity coefficient based on the node similarity coefficient and the second similarity coefficient, and identify the at least one second pair of the table segment and document by identifying top k, with the highest third similarity coefficients, of the additional search group.

According to some aspects, the modified graph comprises the tabular data segments of the subgraph, the documents of the subgraph, a second table segment of the at least one second pair of the table segment and document, and a second document of the at least one second pair of the table segment and document, the tabular data segments of the subgraph and the second table segment are modified tabular data segments, and the documents of the subgraph and the second document are modified documents, and wherein the instructions cause the processor to: input the question into a large language model, receive, from the large language model, whether reconstruction is necessary for the modified tabular data segments, reconstruct the table with the modified tabular data segments, based on the reconstruction being necessary, identify additional tabular data segments relevant to the question in the table, identify additional documents related to the additional tabular data segments by searching for the additional tabular data segments in one of the modified graph and the initial graph, identify a split graph by splitting the modified graph around the modified tabular data segments, and identify the expanded graph based on the split graph, the additional tabular data segments, and the additional documents.

According to some aspects, the instructions cause the processor to: identify the expanded result graph by removing pairs of tabular data segments and documents that are not relevant to the question in the expanded graph.

According to some aspects, the instructions cause the processor to: identify the expanded graph by removing duplicate pairs of tabular data segments and documents in the split graph, based on the reconstruction being unnecessary.

According to some aspects, the instructions cause the processor to: identify the expanded result graph by removing pairs of tabular data segments and documents that are not relevant to the question in the expanded graph.

According to some aspects, the instructions cause the processor to: identify final similarity coefficients between the question and pairs of result tabular data segments and documents included in the expanded result graph, and identify a final graph in which the pairs of the result tabular data segments and documents are sorted based on the final similarity coefficients.

According to some aspects, the instructions cause the processor to: provide the final graph as an answer to the question.

According to some aspects of the disclosure, a method for searching tabular data and documents according to a question, comprises: identifying tabular data segments obtained by dividing a table based on rows, identifying an initial graph comprising a plurality of first pairs of tabular data segments and documents in which the tabular data segments and documents related to the tabular data segments are paired, identifying a first similarity coefficient between a question and each of the plurality of first pairs of the tabular data segments and documents; identifying a subgraph that is part of the initial graph based on the first similarity coefficients, identifying at least one of new tabular data segments and new documents that are different from each of the tabular data segments of the subgraph and the documents of the subgraph included in the subgraph based on the subgraph; identifying at least one second pair of a table segment and a document, which is at least part of the new tabular data segments and the new documents, identifying a modified graph by adding the at least one second pair of the table segment and document to the subgraph, identifying an expanded graph obtained by modifying the modified graph, based on the modified graph, and identifying an expanded result graph based on relevance between the expanded graph and the question.

According to some aspects, the identifying the at least one of the new tabular data segments and the new documents comprises: identifying each of the tabular data segments of the subgraph and the documents of the subgraph as a node; identifying node similarity coefficients between the question and the nodes; and identifying a selected node group by identifying top k (where k is a natural number), with the highest node similarity coefficients, of the nodes.

According to some aspects, the identifying the at least one of the new tabular data segments and the new documents comprises: identifying search results that are a result of searching the initial graph for the new tabular data segments and the new documents that are simultaneously related to the selected node group and the question and are of a different type from the selected node group; identifying second similarity coefficients between the question and the search results; and identifying an additional search group by identifying top k, with the highest second similarity coefficients, of the search results, and wherein the additional search group comprises at least one of the new tabular data segments and the new documents.

According to some aspects, the modified graph comprises the tabular data segments of the subgraph, the documents of the subgraph, a second table segment of the at least one second pair of the table segment and document, and a second document of the at least one second pair of the table segment and document, the tabular data segments of the subgraph and the second table segment are modified tabular data segments, and the documents of the subgraph and the second document are modified documents, and wherein the identifying the expanded graph comprises: inputting the question into a large language model; receiving, from the large language model, whether reconstruction is necessary for the modified tabular data segments; reconstructing the table with the modified tabular data segments, based on the reconstruction being necessary; identifying additional tabular data segments relevant to the question in the table; identifying additional documents related to the additional tabular data segments by searching for the additional tabular data segments in one of the modified graph and the initial graph; identifying a split graph by splitting the modified graph around the modified tabular data segments; and identifying the expanded graph based on the split graph, the additional tabular data segments, and the additional documents.

According to some aspects, the identifying the expanded graph comprises: identifying the expanded graph by removing duplicate pairs of tabular data segments and documents in the split graph, based on the reconstruction being unnecessary.

According to some aspects, identifying final similarity coefficients between the question and pairs of result tabular data segments and documents included in the expanded result graph; identifying a final graph in which the pairs of the result tabular data segments and documents are sorted based on the final similarity coefficients; and providing the final graph as an answer to the question.

In one or more aspects, the present disclosure provides specific improvements to the functionality of computer systems and electronic devices by enabling efficient, dynamic integration of structured data (e.g., tabular data) and unstructured data (e.g., textual documents) in response to natural language queries. Unlike conventional systems that treat structured and unstructured data in isolation or rely on rudimentary fusion strategies, the disclosed technology implements a unified and adaptive approach based on semantic graph modeling. This provides a technological solution to the technical challenge of accurately identifying and retrieving relevant data across heterogeneous formats, which historically required costly, manual inspection or domain-specific engineering.

In one or more aspects, the subject technology improves computer performance by enabling intelligent and adaptive graph construction workflows. Rather than statically indexing all possible combinations of structured and unstructured data, the system builds and modifies graphs dynamically, based on semantic similarity to the query. This architecture significantly reduces unnecessary computation by avoiding exhaustive search across all document-table pairs and instead prioritizing relevance-aware expansion. The process iteratively focuses computational resources on semantically promising regions of the data graph, thereby enhancing query precision and system throughput.

A technical improvement is provided in the system's ability to evaluate and represent semantic relationships between disparate data types using a multi-layered similarity assessment strategy. This involves computing similarity coefficients (or metrics) not just between query and data items (e.g., between the query and each of the first pairs of the tabular data segments and documents) but also across graph nodes representing data elements (e.g., between the query and the nodes). The use of selective nodes can improve accuracy of the search results. The foregoing functionality is not present in traditional search engines, which rely on keyword overlap or rule-based heuristics. By enabling real-time semantic ranking and graph traversal, the system improves the computer's ability to correlate complex, cross-format information structures.

In addition to improved semantic relevance, the system of the present disclosure incorporates a mechanism for structural adaptation using a large language model. When appropriate, the system evaluates whether data representations require reconstruction (e.g., reconstruction of the tabular data) to better align with the semantic intent of the query. This adaptive capability represents a significant advancement over conventional systems, which are typically static and cannot modify internal data relationships based on real-time query analysis. By leveraging the language model to guide graph reconfiguration, the system provides adaptability that materially enhances the underlying technology.

Another technical improvement is the reduction of redundant or irrelevant information. By pruning the graph during and after expansion, the system avoids the inclusion of semantically overlapping or unnecessary data items. This not only improves output quality but also contributes to faster response times and reduced memory usage. These optimizations directly enhance the computer's operational efficiency and address longstanding technical problems in large-scale data integration.

Furthermore, the electronic device includes hardware circuits that implement and execute these functions and operations. These circuits cooperate to handle data segmentation, graph construction, semantic similarity coefficients, and result presentation in a modular and highly efficient manner. The architecture is inherently scalable and can be deployed on edge devices, servers, distributed platforms and other devices. This hardware-level specialization enables real-time processing of complex data relationships in a manner that outperforms conventional implementations.

In addition, the computer-implemented method also reflects a significant advancement in computing capability. It enables a computing system to dynamically process heterogeneous data structures, apply context-specific evaluation criteria, and return output that reflects deep semantic relationship of both the query and the underlying data. The method's use of layered graph construction, adaptive expansion, and context-aware strategies results in responses that are more accurate, relevant, and interpretable, while also improving computational efficiency and scalability for the system.

In one or more aspects, the subject technology provides a technological improvement to how computers process, correlate, and retrieve information from mixed-format data sources. The subject technology goes beyond automation of human activity or implementation of generic functions. Instead, it provides specific solutions to technical problems in data integration and retrieval, utilizing hardware circuit components and advanced semantic modeling methods that improve both accuracy and system performance. These improvements demonstrate practical, concrete enhancements to computer technology.

Various embodiments of the present specification may be implemented as software (e.g., a program) including one or more instructions stored in a storage medium (e.g., the memory 120) readable by a machine (e.g., the search device 100). For example, the processor 110 of the machine (e.g., the search device 100) may call upon at least one of the one or more stored instructions from the storage medium and execute it. This allows the machine to operate to perform at least one function according to the at least one called instruction. The one or more instructions may include code generated by a compiler or code executable by an interpreter. The storage medium readable by the machine may be provided in the form of a non-transitory storage medium. Here, “non-transitory” merely means that the storage medium is a tangible device and does not include signals (e.g., electromagnetic waves), and the term does not distinguish between cases where data is stored semi-permanently and cases where data is stored temporarily in the storage medium.

According to one embodiment, the methods in accordance with various embodiments disclosed herein may be provided in a computer program product. The computer program product may be traded between a seller and a buyer as a commodity. The computer program product may be distributed in the form of a machine-readable storage medium (e.g., compact disc read-only memory (CD-ROM)), or may be distributed online (e.g., downloaded or uploaded) via an application store (e.g., Play Store™) or directly between two user devices (e.g., smartphones). In the case of online distribution, at least part of the computer program product may be at least temporarily stored or temporarily generated in a machine-readable storage medium, such as a memory of a manufacturer's server, an application store's server, or a proxy server.

According to various embodiments, each component (e.g., a module or a program) of the components described above may include a single or plurality of entities. According to various embodiments, one or more components or operations of the foregoing components may be omitted, or one or more other components or operations may be added. Alternatively or additionally, a plurality of components (e.g., modules or programs) may be integrated into a single component. In such a case, the integrated component may perform one or more functions of each of the plurality of components in the same or similar manner as performed by the corresponding components of the plurality of components prior to the integration. According to various embodiments, operations performed by modules, programs, or other components may be performed sequentially, in parallel, iteratively, or heuristically, or one or more of the operations may be performed in a different order, or omitted, or one or more other operations may be added.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

What is claimed is:

1. An electronic device for determining semantic correlations between structured data and unstructured data and data retrieval in response to queries, the electronic device comprising:
a data-acquisition circuit configured to acquire tabular data organized into rows and a query for querying the tabular data;
a data-division circuit configured to divide the tabular data into tabular data segments each comprising one or more of the rows;
a first graph-construction circuit configured to construct an initial graph comprising first pairs of tabular data segments and documents relating to the tabular data segments;
a first similarity-determination circuit configured to determine first similarity coefficients between the query and each of the first pairs of the tabular data segments and documents;
a second graph-construction circuit configured to construct a subgraph that is part of the initial graph based on the first similarity coefficients;
a first data-identification circuit configured to identify, based on the subgraph, at least one of new tabular data segments and new documents that are different from each of the tabular data segments of the subgraph and the documents of the subgraph included in the subgraph;
a second data-identification circuit configured to identify at least one second pair of a tabular data segment and a document which is at least part of the new tabular data segments and the new documents;
a third graph-construction circuit configured to construct a modified graph by adding the at least one second pair of the tabular data segment and the document to the subgraph;
a fourth graph-construction circuit configured to construct an expanded graph by modifying the modified graph based on the modified graph;
a fifth graph-construction circuit configured to construct an expanded result graph based on relevance between the expanded graph and the query; and
a data-handling circuit configured to store or transmit one or more of the expanded graph and the expanded result graph.

2. The electronic device of claim 1, wherein the first graph-construction circuit is further configured to construct the initial graph being formed in an early fusion method.

3. The electronic device of claim 1, further comprising a data-processing circuit configured to provide the query and the initial graph to an external network and further configured to receive the first similarity coefficients from the external network.

4. The electronic device of claim 3, wherein the second graph-construction circuit is further configured to construct the subgraph by identifying top k (where k is a natural number) of the first pairs of the tabular data segments and documents with highest of the first similarity coefficients.

5. The electronic device of claim 1, further comprising:
a node-construction circuit configured to construct each of the tabular data segments of the subgraph and the documents of the subgraph as a node;
a second similarity-determination circuit configured to determine node similarity coefficients between the query and the nodes; and
a third data-identification circuit configured to identify a selected node group by identifying top k (where k is a natural number) of the nodes with highest of the node similarity coefficients.

6. The electronic device of claim 5, further comprising:
a fourth data-identification circuit configured to identify search results that are a result of searching the initial graph for related tabular data segments and related documents that are simultaneously related to the selected node group and the query and are of a different type from the selected node group;
a third similarity-determination circuit configured to determine second similarity coefficients between the query and the search results; and
a fifth data-identification circuit configured to identify an additional search group by identifying top k of the search results with highest of the second similarity coefficients, wherein the additional search group comprises at least one of the new tabular data segments and the new documents.

7. The electronic device of claim 6, further comprising:
a sixth data-identification circuit configured to identify a third similarity coefficient for each of the new tabular data segments and the new documents, wherein the second data-identification circuit is further configured to identify the at least one second pair of the tabular data segment and the document based on the third similarity coefficients.

8. The electronic device of claim 7, wherein:
the sixth data-identification circuit is further configured to identify the third similarity coefficients based on the node similarity coefficients and the second similarity coefficients; and
the second data-identification circuit is further configured to identify the at least one second pair of the tabular data segment and the document by identifying top k of the additional search group with highest of the third similarity coefficients.

9. The electronic device of claim 1, wherein:
the modified graph comprises the tabular data segments of the subgraph, the documents of the subgraph, a second tabular data segment of the at least one second pair of the tabular data segment and the document, and a second document of the at least one second pair of the tabular data segment and the document;
the tabular data segments of the subgraph and the second tabular data segment are modified tabular data segments; and
the documents of the subgraph and the second document are modified documents,
wherein the electronic device further comprises:
a data-forwarding circuit configured to provide the query to a large language model and receive an indication from the large language model indicating whether reconstruction is necessary for the modified tabular data segments;
a data-reconstruction circuit configured to reconstruct the tabular data with the modified tabular data segments based on the reconstruction being necessary;
a seventh data-identification circuit configured to identify additional tabular data segments relevant to the query in the tabular data;
an eighth data-identification circuit configured to identify additional documents related to the additional tabular data segments by searching for the additional tabular data segments in one of the modified graph and the initial graph; and
a sixth graph-construction circuit configured to construct a split graph by splitting the modified graph around the modified tabular data segments, and
wherein the fourth graph-construction circuit is further configured to construct the expanded graph based on the split graph, the additional tabular data segments, and the additional documents.

10. The electronic device of claim 9, wherein the fifth graph-construction circuit is further configured to construct the expanded result graph by removing pairs of tabular data segments and documents that are not relevant to the query in the expanded graph.

11. The electronic device of claim 9, wherein the fifth graph-construction circuit is further configured to construct the expanded result graph by removing duplicate pairs of tabular data segments and documents in the split graph based on the reconstruction being unnecessary.

12. The electronic device of claim 11, wherein the fifth graph-construction circuit is further configured to construct the expanded result graph by removing pairs of tabular data segments and documents that are not relevant to the query in the expanded graph.

13. The electronic device of claim 1, further comprising:
a fourth similarity-determination circuit configured to determine final similarity coefficients between the query and pairs of result tabular data segments and documents included in the expanded result graph; and
a seventh graph-construction circuit configured to construct a final graph in which the pairs of the result tabular data segments and documents are sorted based on the final similarity coefficients.

14. The electronic device of claim 13, wherein the data-handling circuit is further configured to present the final graph as responsive to the query.

15. A computer-implemented method for determining semantic correlations between structured data and unstructured data and data retrieval in response to queries, the computer-implemented method comprising:
acquiring tabular data organized into rows and a query for querying the tabular data;
dividing the tabular data into tabular data segments each comprising one or more of the rows;
constructing an initial graph comprising first pairs of tabular data segments and documents relating to the tabular data segments;
determining first similarity coefficients between the query and each of the first pairs of the tabular data segments and documents;
constructing a subgraph that is part of the initial graph based on the first similarity coefficients;
identifying, based on the subgraph, at least one of new tabular data segments and new documents that are different from each of the tabular data segments of the subgraph and the documents of the subgraph included in the subgraph;
identifying at least one second pair of a tabular data segment and a document, which is at least part of the new tabular data segments and the new documents;
constructing a modified graph by adding the at least one second pair of the tabular data segment and the document to the subgraph;
constructing an expanded graph by modifying the modified graph based on the modified graph;
constructing an expanded result graph based on relevance between the expanded graph and the query; and
storing or transmitting one or more of the expanded graph and the expanded result graph.

16. The computer-implemented method of claim 15, wherein the identifying the at least one of the new tabular data segments and the new documents comprises:
constructing each of the tabular data segments of the subgraph and the documents of the subgraph as a node;
determining node similarity coefficients between the query and the nodes; and
identifying a selected node group by identifying top k (where k is a natural number) of the nodes with highest of the node similarity coefficients.

17. The computer-implemented method of claim 16, wherein the identifying the at least one of the new tabular data segments and the new documents comprises:
identifying search results that are a result of searching the initial graph for the new tabular data segments and the new documents that are simultaneously related to the selected node group and the query and are of a different type from the selected node group;
determining second similarity coefficients between the query and the search results; and
identifying an additional search group by identifying top k of the search results with highest of the second similarity coefficients, and
wherein the additional search group comprises at least one of the new tabular data segments and the new documents.

18. The computer-implemented method of claim 15, wherein:
the modified graph comprises the tabular data segments of the subgraph, the documents of the subgraph, a second tabular data segment of the at least one second pair of the tabular data segment and the document, and a second document of the at least one second pair of the tabular data segment and the document;
the tabular data segments of the subgraph and the second tabular data segment are modified tabular data segments; and
the documents of the subgraph and the second document are modified documents, and
wherein the identifying the expanded graph comprises:
inputting the query into a large language model;
receiving an indication, from the large language model, indicating whether reconstruction is necessary for the modified tabular data segments;
reconstructing the tabular data with the modified tabular data segments, based on the reconstruction being necessary;
identifying additional tabular data segments relevant to the query in the tabular data;
identifying additional documents related to the additional tabular data segments by searching for the additional tabular data segments in one of the modified graph and the initial graph;
constructing a split graph by splitting the modified graph around the modified tabular data segments; and
constructing the expanded graph based on the split graph, the additional tabular data segments, and the additional documents.

19. The computer-implemented method of claim 18, wherein the constructing the expanded graph comprises:
constructing the expanded graph by removing duplicate pairs of tabular data segments and documents in the split graph, based on the reconstruction being unnecessary.

20. The computer-implemented method of claim 15, further comprising:
determining final similarity coefficients between the query and pairs of result tabular data segments and documents included in the expanded result graph;
constructing a final graph in which the pairs of the result tabular data segments and documents are sorted based on the final similarity coefficients; and
presenting the final graph responsive to the query.
